(19) United States
(12) Patent Application Publication
(10) Pub. No.: US 2012/0330735 A1
(43) Pub. Date: Dec. 27, 2012

(54) ANALYTICS SYSTEM AND METHOD FOR MONITORING AND FACILITATING PROMOTION DISTRIBUTION

(76) Inventor: Dave Gasparine, Las Vegas, NV (US)

(21) Appl. No.: 13/404,882

(22) Filed: Feb. 24, 2012

Related U.S. Application Data
(63) Continuation-in-part of application No. 13/168,763, filed on Jun. 24, 2011.

(51) Int. Cl. G06Q 30/02

(52) U.S. Cl. 705/14.16; 705/14.4

(57) ABSTRACT

An analytics system for monitoring consumer interactions with promotional activities provides incentives to further distribution of a merchant's promotions. The analytics system may distribute one or more promotions to consumers electronically directly or indirectly. A promotion distribution system may be provided to transmit promotions from merchants to users and from users to other users. An activity monitor may be provided to monitor promotion redemption activity. If a promotion shared by one user is redeemed by another, the sharing user may be rewarded to encourage user distribution of promotions.

### CROSS-REFERENCE TO RELATED APPLICATION

This application is a continuation-in-part of U.S. patent application Ser. No. 13/168,763, titled Analytics System and Method for Monitoring Consumer Interaction with Merchant Promotional Activities, filed Jun. 24, 2011.

### BACKGROUND OF THE INVENTION

1. Field of the Invention

The invention relates generally to transaction monitoring systems, and in particular to an analytics system and method for coupon purchases.

2. Related Art

Advertisements, promotions, and other marketing has become pervasive in society. Merchants continuously seek advertising and promotion to develop and grow their businesses. Traditionally, a merchant or business establishes a relationship with a marketing company to promote its goods or services. The marketing company then works to distribute information promoting the goods or services to the public. The marketing company may create promotional material and actively promote the merchant or business. Alternatively, the marketing company may simply accept promotional material and distribute such material to the public.

This process, with the marketing company functioning as an intermediary between a merchant and its customers, is not streamlined and typically adds additional costs when promoting a merchant or business. In addition, this intermediary processes necessarily hinders direct communication between a merchant or business and its customers.

From the discussion that follows, it will become apparent that the present invention addresses the deficiencies associated with the prior art while providing numerous additional advantages and benefits not contemplated or possible with prior art constructions.

### SUMMARY OF THE INVENTION

An analytics system and method are disclosed herein. The analytics system provides the benefit of automatic tracking of consumer activity with regard to a promotion being conducted by a merchant. Various reports may be generated for the merchant to evaluate the performance of its promotions. The analytics system may be used as a platform for electronically distributing promotions to consumers. This distribution may occur directly from merchants to users or indirectly from users to other users. The analytics system may reward users who share promotions to encourage user distribution of promotions. This is highly advantageous as a way of furthering distribution of a merchant's promotions. The consumer activity surrounding the promotions, such as redemptions and sharing of promotions, may then be tracked to provide feedback to merchants while also providing discounts or other benefits to consumers.

The analytics system disclosed herein may have various configurations. In one embodiment for example, an analytics system for distributing merchant promotions may comprise one or more servers configured to transmit a promotion to a first consumer device, transmit the promotion to one or more second consumer devices upon receiving a sharing request from the first consumer device, and receive interaction data from the second consumer devices. The interaction data may identify a user account associated with the first consumer device. In addition, the interaction data may include an identifier indicating that the promotion has been redeemed with the second consumer devices.

One or more storage devices may be configured to store the interaction data, and record a reward in the user account identified by the interaction data upon receipt of the interaction data. In this manner, a user that shares a promotion that is later redeemed may be rewarded to encourage further sharing of the promotion. The reward may be various items of value, including credits, points, currency, and prizes. It is noted that the storage devices may be further configured to store one or more reward definitions that govern what reward will be given to and recorded in the user account.

It is noted that the servers may be configured to transmit the promotion to the first consumer device with a first transmission method, and to the second consumer devices with a second transmission method with the first transmission method being distinct from the second transmission method. For example, only the second transmission method may send promotions by SMS, email, push notification, or instant messaging transmissions.

Also, the servers may be configured to receive one or more user identifiers identifying one or more user accounts associated with the second consumer devices. In this manner, promotions may be sent to these second users via their user accounts.

In another exemplary embodiment, an analytics system may comprise a promotion distribution system configured to transmit one or more promotions to one or more first consumer devices, and an activity monitor configured to receive interaction data identifying a redemption of the promotions using one or more second consumer devices. The interaction data may identify one or more user accounts associated with the first consumer devices.

The activity monitor may also be configured to apply a reward to the user accounts by storing an indicator identifying the reward. The indicator may be stored on a storage device and be associated with the user accounts to associate the reward to the user accounts. Similar to above, the reward may be one or more items of value such as credits, points, currency, and prizes.

The promotion distribution system may be configured to transmit the promotions to the second consumer devices upon receipt of a share request from the first consumer devices. The share request may identify one or more user accounts associated with the second consumer devices. The share request may identify one or more user identifiers selected such as phone numbers or email addresses.

The analytics system may include client software or machine readable code in some embodiments. A storage device may be configured to store the machine readable code, and it is contemplated that a client device may retrieve the machine readable code from the storage device through various communication links. The machine readable code may be configured to allow a client device to communicate with the analytics system. For example, the machine readable code may cause a client device to generate a share request when executed by the first consumer devices.

Various methods for promotion distribution are disclosed herein as well. Fore example, a method for distributing promotions with an analytics system might comprise receiving a promotion from a merchant via a merchant device, receiving a reward definition for the promotion from the merchant, and transmitting the promotion to one or more first consumer devices via a communication device.

The method also includes receiving interaction data indicating a redemption of the promotion from one or more second consumer devices, determining a reward based on the reward definition after receiving the interaction data, and associating the reward with one or more user accounts associated with the first consumer devices. It is noted that a notification may be transmitted to the first consumer device after the interaction data is received. This informs the sharing user that a promotion he or she shared has been redeemed. Information identifying the reward may also be provided to the first consumer devices upon receipt of a query from the first consumer devices.

This allows the user to determine what reward he or she has received.

During execution of the method, the promotion may be transmitted from the first consumer devices to the second consumer devices. This effectuates user to user sharing of promotions. Alternatively or in addition, a share request identifying at least one of the second consumer devices may be received from the first consumer devices. Subsequently, the promotion may be transmitted from the analytics system to the second consumer device after the share request is received. This effectuates user to user sharing through the analytics system.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating an exemplary analytics system in communication with merchant and consumer devices;

FIG. 2 is a block diagram illustrating components of an exemplary analytics system;

FIG. 3A illustrates an exemplary promotion;

FIG. 3B illustrates an exemplary promotion;

FIG. 4 is a flow diagram illustrating operation of an exemplary analytics system;

FIG. 5 illustrates an exemplary report generated by an analytics system; and

FIG. 6 is a flow diagram illustrating operation of an exemplary analytics system when sharing promotions.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the analytics system herein collects information regarding the usage, success, or lack thereof of a merchant's promotional activity. The analytics system may do so in an automated fashion so that this information can be collected without interrupting purchase transactions or annoying consumers. In addition, the analytics system may combine the collected information and display it such that it may be easily reviewed for pertinent data points. Using this data, merchants may alter their promotional strategy such as by altering one or more coupons, offers, or other marketing materials. In addition, merchants may identify promotions that work well for their particular businesses.

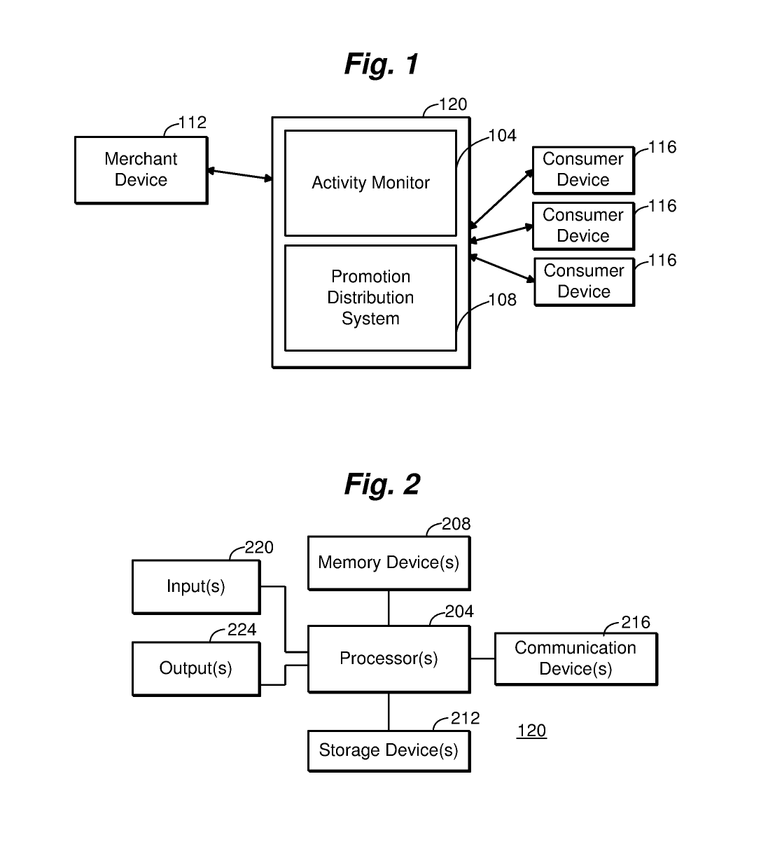

The analytics system will now be described with regard to FIG. 1. In one or more embodiments, the analytics system 120 may comprise one or more subsystems. For example, as shown, the analytics system 120 comprises an activity monitor 104 and a promotion distribution system 108. It is contemplated that the analytics system 120 could comprise either or both these subsystems in some embodiments.

In general, the promotion distribution system 108 allows merchants to distribute their promotions to consumers. In some embodiments, as will be described further below, the promotion distribution system 108 may also allow merchants to create their own promotions and/or may accept promotions directly from merchants for distribution to the consumers. Merchants may access the promotion distribution system 108 with a merchant device 112, such as a computer or other device.

Typically, promotion distribution will occur electronically, such as by wired or wireless transmission, to a consumer device 116 belonging to a consumer. For example, the consumer device 116 may be a mobile device such as a cell phone, PDA, laptop, tablet, or smart phone. A mobile device is advantageous in that the consumer can have such a device on his or her person virtually everywhere. It is noted that the consumer device 116 could be non-mobile device such as a desktop computer or the like, but typically the client device will be mobile to allow promotions to be received virtually anywhere.

It is contemplated that a merchant device 112 and consumer device 116 could both be various devices capable of accessing and communicating with the analytics system 120. For example, any mobile or non-mobile device capable of properly communicating with the analytics system 120 could be a merchant device 112 or a client device 116. This permits both merchants and consumers to use the analytics system 120 from almost anywhere. It is noted that such a device may be configured with machine readable code stored on a memory device to properly communicate (and thus access) the analytics system 120.

The activity monitor 104 will typically be configured to monitor usage or other activities related to the promotions. The activity monitor 104 may monitor activities at the analytics system 120, at the consumer devices 116, or both. For example, the activity monitor 104 may monitor the number of promotions sent, the number received, the number used or redeemed. The activity monitor 104 may also monitor consumer activities and characteristics. For example, the activity monitor 104 may monitor where promotions are used and the demographics of consumers utilizing the promotions. The activity monitor 104 may also record the information it monitors or collects. In this manner, the collected information may be retrieved for analysis and reporting to a merchant 112.

As shown in FIG. 1, the activity monitor 104 and promotion distribution system 108 are within an analytics system 120. It is noted that though illustrated as one device, the activity monitor 104 and promotion distribution system 108 (and/or other subsystem(s)) may be separate components and may be remote from one another. For example, various subsystems of the analytics system 120 may be remote from one another and communicate via one or more network or other communication links, if necessary. In addition, it is contemplated that a single activity monitor 104 may monitor promotion activity resulting from or at multiple promotion distribution systems 108. In this manner, consumers 116 may utilize a variety of promotion distribution systems 108, such as their own promotion distribution systems or third party distribution systems in addition to or instead of the promotion distribution system of the analytics system 120.

FIG. 1 also shows how merchant devices 112 and consumer devices 116 may communicate with the analytics system 120. In one or more embodiments, merchant devices 112 may effectuate the distribution of promotions from the promotion distribution system 108 and view information collected by the activity monitor 104 via a communication link with the analytics system 120. Consumer devices 116 may communicate information regarding the use, success or lack thereof of one or more promotions to the activity monitor 104, or the activity monitor may request such information from the mobile devices.

In one or more embodiments, the analytics system 120 may be a hardware device configured to operate as described herein. For example, the analytics system 120 may be a server, network appliance or other device that performs the functions disclosed herein. FIG. 2 is a block diagram illustrating an exemplary analytics system 120. As can be seen, the analytics system may comprise one or more processors 204, memory devices 208, storage devices 212, communication devices 216, input devices 220, and/or output devices 224. It is noted that in some cases, memory devices 208 and storage devices 212 may perform similar data storage functions and thus both may not be provided in some embodiments.

In general, a processor 204 will be configured to control or operate various components of the analytics system 120 to provide the functionality described herein. In one or more embodiments, the processor 204 may operate according to one or more instructions. These instructions may be hard wired into the processor 204 or may be machine readable code retrieved from a storage medium for execution by the processor. For example, in one or more embodiments, the instructions may be retrieved from a storage device 212 for execution by the processor 204. Some exemplary storage devices 212 may utilize magnetic, optical, or flash based storage technology. The instructions may be configured such that the analytics system 120 has activity monitoring capability, promotion distribution capability, or both.

A storage device 212 may also or alternatively store promotion information. For example, one or more coupons or offers may be stored on the storage device such as for the promotion distribution system 108 to distribute. As another example, the storage device 212 may store the information collected by the activity monitor 104. It is noted that the storage device 212 may be a local storage device, such as a hard drive or the like within the same enclosure of the processor 204. Alternatively, the storage device 212 may be remote from the processor 204, such as an external storage device or network attached storage or the like. One or more communication devices 216 may be used to communicate which such storage devices 212.

One or more memory devices 208 may be provided in some embodiments. Typically, a memory device 208 is used for short term storage such as RAM or cache memory. A memory device 208 may be read only, such as ROM, or read write, such as in the case of RAM or cache memory. Since, as described herein, memory devices 208 and storage devices 212 are both capable of retrievably storing data, it is contemplated that they may be used interchangeably at least for some tasks.

As stated, the analytics system 120 may comprise one or more communication devices 216 configured to allow communication with one or more remote devices. For example, the analytics system 120 may communicate with devices, such as merchant devices 112 and/or consumer devices 116, via a communication device 216. Various communication devices 216 may be provided so that the analytics system 120 can communicate through a variety of communication links or mediums. For example, wired or wireless communication devices 216 may be provided. In addition, the communication devices 216 may utilize various communication protocols to establish communications and to transfer data. In a networked embodiment for example, a communication device 216 may utilize TCP/IP (or other communication protocol).

It is contemplated that the analytics system 120 may be controlled remotely through a communication device 216, such as at a remote terminal (e.g., a merchant device 112) in communication with the analytics system. Alternatively or in addition, the analytics system 120 may have one or more input devices 220 and/or one or more output devices 224. For example, the analytics system 120 may have a keyboard, mouse, or other input device 220 to allow a user to interact with and control the analytics system 120. The analytics system 120 may have a display screen, speakers, and other output devices 224 to provide feedback of various types to the user.

The analytics system 120 may have different types of users. For example, merchants may utilize the analytics system 120 by requesting, receiving, and/or reviewing information regarding their promotion activity that has been collected by the activity monitor. Merchants may also create promotions of various sorts and distribute them using the promotion distribution system of the analytics system 120. Consumers may utilize the analytics system 120 by requesting, receiving, and/or redeeming promotions provided by the merchants. The analytics system 120 may also have administrative users or administrators that maintain, configured, and/or upgrade the analytics system. The analytics system's users may interact with the analytics system in these ways through the system's communication device(s) 216, input device(s) 220, and/or output device(s).

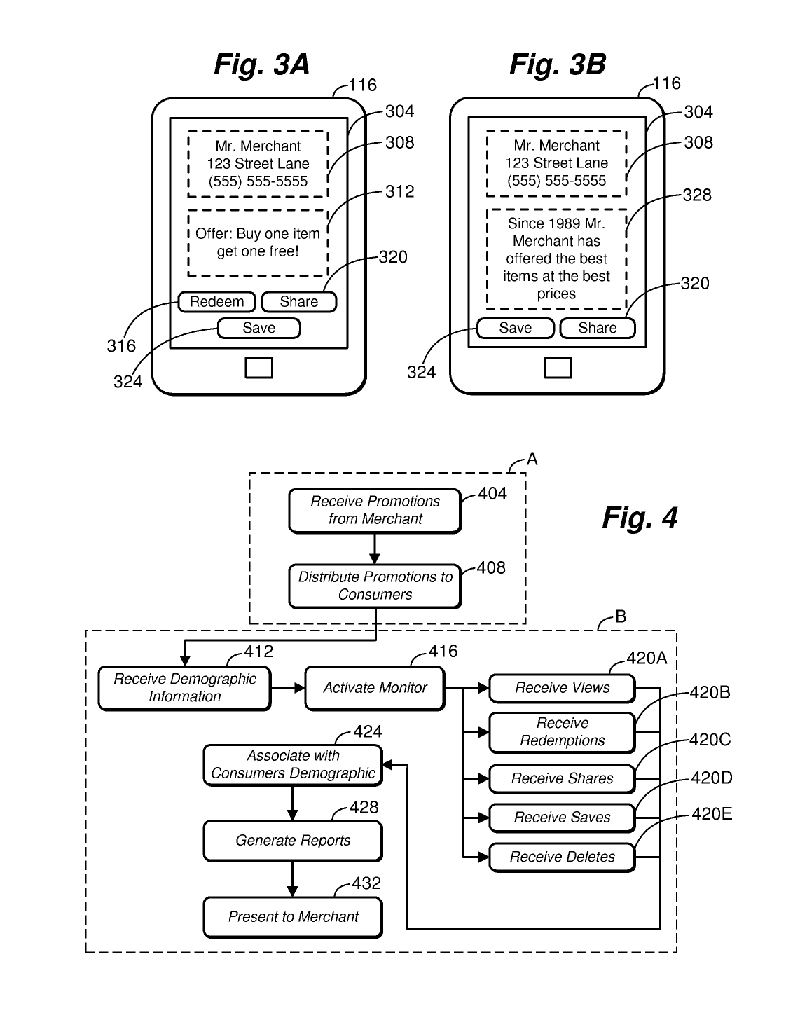

As stated, the analytics system 120 generally utilizes its activity monitor 104 to track the usage, success, or lack thereof of a merchant's promotions by monitoring consumer activity related to the promotions the merchant has distributed (i.e., provided to consumers). FIG. 3A illustrates an exemplary promotion 304 that may be distributed by the analytics system 120, such as via its promotion distribution system. It is noted that the analytics system 120 may provide a user interface (e.g., a graphical user interface) or other interface which accepts promotion information that forms a promotion or coupon. Typically, the promotion data that forms a promotion 304 will be received via an input device or a communication device of the analytics system. For example, the merchant may utilize a keyboard and mouse or his or her merchant device to send a promotion 304 to the analytics system 120. The analytics system 120 may then store the promotion on a storage device for subsequent retrieval and distribution to one or more consumer devices.

Typically, the promotion 304 will be electronic and thus may be displayed on a display screen for viewing. For example, a promotion 304 may be displayed on screen of a consumer device 116. Promotions 304 may include various information. For example, a promotion 304 may provide an enticing offer or other benefit to a consumer (such as shown in FIG. 3A). In addition or alternatively, a promotion 304 may provide marketing information or merchant information to a consumer (such as shown in FIG. 3B).

FIG. 3A illustrates an exemplary promotion 304 comprising an offer 312. In the example of FIG. 3A, the offer 312 is for buy one get one free of an item at the offering merchant's business. An offer 312 may include various discounts or consumer benefits. Also, the offer 312 may include one or more images, animations, videos, and/or sounds if desired. Merchant information 308 may be part of a promotion 304 in some embodiments. For example, merchant information 308 such as the name, location, website, and/or contact information for a merchant may be provided. Merchant information 308 may optionally include a description of the merchant or its goods and services.

Since the promotion 304 is typically electronic, it may accept user input. For example, the promotion 304 may have one or more controls, such as buttons, sliders, switches, scroll bars that can be used to interact with the promotion, such as to retrieve additional information, redeem the promotion, share the promotion, and/or save the promotion for later use. The promotion 304 shown in FIG. 3A provides input buttons that may be used to execute various functionality. To illustrate, the promotion 304 of FIG. 3A has a “Redeem” button 316, a “Share” button 320, and a “Save” button 324. It is noted that the promotion 304 of FIG. 3A is exemplary and that fewer or additional buttons may be provided. For example, only a “Redeem” button 316 may be provided in some embodiments.

The “Redeem” button 316 may be configured to allow the offer 312 to be redeemed when the “Redeem” button is engaged. For example, pressing the “Redeem” button 316 may trigger a redemption process whereby the offer 312 is redeemed to give a consumer the discount or other benefit presented therein. The redemption process may include confirmation that the offer 312 is valid. The redemption process may also or alternatively include expiring or deactivating the offer 312 so that it can not be used again. For example, the offer 312 may be identified on the analytics system, such as in a database, and be marked as redeemed, expired, or deactivated once the offer has been redeemed.

In one embodiment, the redemption process may include scanning or reading one or more barcodes or other identifiers at a merchant's location. For example, a consumer device may scan a barcode using a scanner, camera, or the like. A consumer device may also or alternatively read an identifier via RF signals using one or more transceivers. Typically, the barcode will be used to identify a merchant, such as to verify that an offer 312 is being redeemed at the merchant that provided it. A consumer may redeem an offer simply by reading the identifier with his or her device. Alternatively, the consumer may first engage the “Redeem” button and then read the identifier to allow the system to verify the offer 312 prior to redeeming it. If the identifier does not match, the offer may not be successfully redeemed in one or more embodiments.

The “Share” button 320 may be used to share a promotion 304 with others. For example, the promotion 304 may be transmitted to other consumers via social networking sites, email, SMS, or other communication mediums. Consumers receiving a shared promotion may be permitted to redeem the promotion 304 themselves in one or more embodiments.

The “Save button 324 may be used to store or tag promotions 304. The consumer can then retrieve the promotions 304 he or she has saved, and redeem them if desired. In this way, the consumer device can help a consumer remember particular promotions 304 and allow them to be easily retrieved for redemption.

Interactions with a promotion 304 may be transmitted from a consumer device to the analytics system. In one or more embodiments, the interactions may be recorded by an activity monitor of the analytics system, such as described above. Interactions may include, viewing the promotion, redeeming the promotion, saving the promotion, deleting the promotion, and sharing the promotion. On some consumer devices, a consumer may visit a merchant's website or call a merchant directly from the promotion 304, such as by engaging a button, link, or the like presented with the promotion 304. When a user engages in such interaction, data identifying the interaction may be transmitted from the consumer device to the analytics system for storage. For example, a message identifying the type of interaction, user engaging in the interaction, time of interaction, promotion undergoing interaction, and/or location of the user may be sent to the analytics system.

It is contemplated that the consumer device may also collect demographic information from a consumer. For example, the consumer may provide contact information (e.g., email, phone number, address), his or her age or date of birth, sex, and other information. Demographic information may be collected when a user first signs up or logs in, such as when creating a user account. This information may then be stored by the analytics system so that it need not be entered again. Typically, the analytics system will allow the consumer to decide what information the consumer wishes to provide, though it is contemplated that some demographic information may be required in some embodiments. The information may but need not be precise. For example, rather than a residence address, a consumer may provide a zip code or city and state. As another example, the consumer may provide an age range rather than a particular age or date of birth.

FIG. 3B illustrates another exemplary promotion 304. As can be seen this promotion 304 also includes merchant information 308 as well as a “Share” button 320 and a “Save” button 324. The promotion 304 also has marketing information 328. In this embodiment, the marketing information 328 is provided instead of the offer 312, such as that shown in FIG. 3A. Marketing information 328 may be information, that promotes a merchant without offering a benefit per se. This includes a variety of information. For example, marketing information 328 may explain the advantages of utilizing a particular merchant, provide information about the merchant, present announcements from a merchant, and the like. In general, marketing information 328 cannot be redeemed, but may be used to increase a merchant's consumer base and advertise the merchant.

Similar to above, the “Share” button 320 may be used to share the promotion 304 with other consumers. Here, engaging the “Share” button 320 would typically cause the marketing information 328 to be shared with other consumers through social media, email, SMS, or other communication mediums. Also similar to above, the “Save” button 324, when engaged, would store the promotion 304 for convenient retrieval. This is beneficial in helping the consumer remember new merchants that may need in the future. The consumer may save such merchants' promotions 304 and refer back to them when their services are needed.

Interactions with promotions 304 containing marketing information 328 may also be transmitted to the analytics system, such as described above. For example, interactions such as viewing the promotion 304, sharing the promotion, saving the promotion, deleting the promotion, or the like may be transmitted to a communication device of the analytics system. In this manner, promotions 304 of various types can be monitored by the analytics system's activity monitor.

FIG. 4 is a flow diagram illustrating operation of an exemplary analytics system. Portion A and Portion B as indicated by the dashed lines show an exemplary division between tasks performed by the promotion distribution system and activity monitor, respectively. It is noted that various tasks may be performed by various components of the analytics system and that the promotion distribution system and activity monitor may perform tasks other than those shown in the example of FIG. 4. Though shown in a particular order in FIG. 4, it will be understood that various steps may be performed in various sequences.

At a step 404, one or more promotions may be received from one or more merchants. As disclosed above, the merchants may use their merchant devices to transmit data forming their promotions to the analytics system. It is contemplated that merchants may identify whether marketing information and/or offers are in a promotion. In addition, the merchants may define a start date and an end or expiration date for a promotion. The promotions may then be stored.

At a step 408 the analytics system may distribute the promotions to one or more consumers. Typically, this will occur by sending individual promotions to one or more consumer devices. For example, the analytics system may transmit data via a network or other communication medium to one or more consumer devices. It is noted that consumers may specify which types of promotions they wish to receive. For example, consumers may identify categories of merchants (e.g., auto, beauty, food, etc. . . . ) from which promotions may be received. Likewise, merchants may identify a category in which their promotions belong (e.g., auto, beauty, food, etc. . . . ). This allows the merchants to self-select which categories their promotions belong in.

At a step 412, the analytics system may receive demographic information from individual consumers. It is noted that demographic information may be received at any time and need not be received after the distribution of promotions. In one embodiment, demographic information may be received via an account registration or creation process. For example, a consumer may be prompted to create an account by entering authorization information (e.g., username and password) and any demographic information the consumer wishes to provide (e.g., sex, age or age range, residence address or residence zip code/city and state).

The account is beneficial in that it allows demographic information to be easily associated with the activities/interactions of consumers. In some embodiments, the consumer may not be permitted to view promotions until an account has been created. In other embodiments, the consumer may be permitted to view but not redeem promotions until an account has been created.

At a step 416, monitoring by the analytics system may be activated. It is noted that this step may occur at other times. For example, monitoring may be activated before promotions have been received at step 404, in some embodiments. In general, activation of monitoring causes the analytics system to be in a state where it is ready to receive data from consumer devices. Typically, the data receivable on activation will be the data identifying or recording user interactions with merchant promotions.

FIG. 4 illustrates some exemplary interaction data that may be received. As can be seen, interaction data reporting the viewing, redemption, sharing, saving, or deletion of a promotion may be received by the analytics system at steps 420A-420E, respectively. For example, as described above, if a consumer views Promotion X, his or her consumer device may report that Promotion X has been viewed. The consumer device may also identify itself and/or the consumer that viewed Promotion X. For example, the consumer device may report that Promotion X was viewed by Consumer 1 using Device 23. An identification scheme whereby individual consumer devices and consumers may be uniquely identified may be used to accomplish this. In addition, the consumer device may report other information as part of interaction data. For example, the date and/or time of interaction, location of the consumer device, or both may be reported.

At a step 424, the interaction data received at step 420 may be associated with data from a consumer's account. For example, data identifying a consumer or the consumer's device may be used to associate the consumer's activity or interaction with regard to a promotion to the consumer's account information. Since the account information may contain demographic information, the interaction data may be associated with demographic information in this manner. To illustrate, if Consumer 1 previously provided an Age Range 1 and/or Zip Code 1, Consumer 1's interaction with Promotion X can now be associated with this demographic information by the analytics system. In this manner, it is now known that at least one consumer of Age Range 1 and at Zip Code 1 has at least viewed Promotion X. It can thus be seen that as a number of consumers view (or conduct other interactions with promotions) a collection of interactions for various promotions can be built and stored.

At a step 428, the stored interaction data may be used to generate one or more reports of various sorts. It is contemplated that the analytics system may accept various queries or requests and generate reports accordingly. For example, a merchant may request the age range of all consumers that viewed a particular promotion. It can be seen that the merchant may include various characteristics of interactions and consumer demographics in his or her request. For example, rather than or in addition to views of a promotion, the merchant can request redemptions, shares, saves, and/or deletions of a promotion. Likewise, the merchant can request a report including one or more of such interactions of a promotion for consumers from one or more particular zip codes. In addition, the merchant may request a report for multiple promotions rather from a single promotions. For example, the merchant may request all redemptions (or redemptions for consumers of a particular demographic) for all of his or her promotions, a category of his or her promotions, or other promotions sharing at least one common characteristic.

Once one or more reports are generated, they may be provided to the requesting merchant at a step 432. In one or more embodiments, this may occur by transmitting the report to the merchant's merchant device where it may be viewed, printed, or otherwise used. For example, the report may be a file, webpage, or other data that is presentable via a merchant device. In some embodiments, the report may be interactive allowing the merchant to focus on particular aspects of the report. In addition, it is contemplated that the merchant may alter or change the request that generated the report to receive a different report as he or she desires. The request and any changes thereto may be generated and sent from the merchant's merchant device.

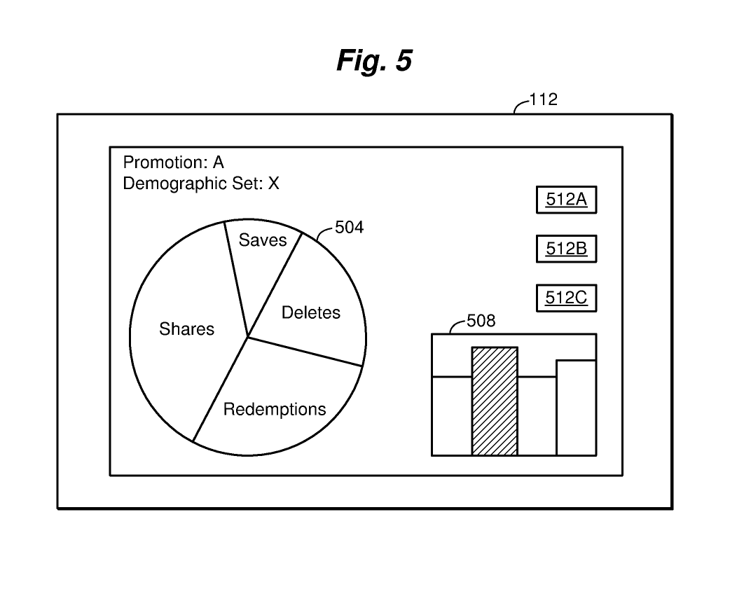

The report may comprise text, graphics, and other information. FIG. 5 provides an exemplary report presented on a merchant device 112. As can be seen, the merchant has requested a report on Promotion A in FIG. 5. The report comprises a pie chart 504 identifying the percentage of consumers shared, saved, deleted, or redeemed Promotion A. A bar graph 508 or other data visualization (including text) could be used as well or instead of the pie chart 504. In addition, a single report may contain multiple data visualizations for multiple merchant requests or queries. One or more buttons or controls 512A-512C may be provided to allow the merchant to interact with a report. For example, the merchant may alter his or her request using one or more controls 512A-512C. It is contemplated that data visualizations may also be interactive. For example, the merchant may click on or otherwise engage a data visualization to “zoom in” on particular data sets. To illustrate, clicking the “Deleted” portion of the pie chart 504 may cause a new data visualization to be displayed that identifies demographics of consumers that have deleted Promotion A.

This provides a report that is easily understandable to the merchant. The merchant can then adjust his or her promotions to increase or decrease particular types of interactions with his or her promotions. For example, the merchant may alter promotions to increase redemptions over saves. The merchant may run multiple reports for a comparison between various promotions. In this manner, the merchant can quickly identify promotions that accomplish the merchant's goals and characteristics thereof. The merchant can then include such characteristics in his or her other promotions to increase their effectiveness or success rate. In addition, the merchant may define his own measure(s) of success and change his or her promotions to meet such measure(s).

The analytics system is highly advantageous to merchants, while providing repeated benefits to consumers in the form of merchant promotions. As can be seen from the above, the analytics system automatically collects consumer activity and interaction with merchant's promotions so that merchants can determine their success or lack thereof virtually in real time. Since consumers receive the benefit of the merchant's promotions, the consumers also benefit while being enticed or encouraged to continue using the analytics system.

As stated above with regard to FIGS. 3A-3B, the analytics system is capable of facilitating sharing of promotions 304 by users (i.e., individuals/entities who are not merchants). In one or more embodiments, promotions 304 may be shared between users regardless of whether or not such users have created a user account.

Referring to FIG. 1, it is noted that the analytics system 120 or various portions thereof may be configured to facilitate sharing of promotions. For example, in one or more embodiments, the promotion distribution system 108 and/or activity monitor 104 may facilitate this sharing. To illustrate, the promotion distribution system 108 may provide functionality to transmit promotions between users in one or more embodiments. For example, the promotion distribution system 108 may receive one or more signals from a consumer device identifying a promotion to be shared and/or one or more users to share the promotion with. The promotion distribution system 108 may then transmit the promotion to these users, such as described above.

As described with regard to FIG. 4, the activity monitor 108 may receive various types on interaction data, including receiving interaction data indicating that a promotion has been redeemed (step 420B) or shared (step 420C). With regard to sharing of promotions between users, the activity monitor 108 may record when a promotion is shared at step 420C. At step 420B, the activity monitor 108 may record when a promotion shared by a first user is redeemed by a second user. As stated above, this recorded information may then be used to generate one or more reports related to the promotions distributed by the analytics system.

In one or more embodiments, both users and non-users will use a consumer device 116, such as a smart phone, PDA, tablet, or other computing device, in receiving and redeeming shared promotions. It is contemplated however that promotions could be shared by non-electronic methods, such as via mailings and the like.

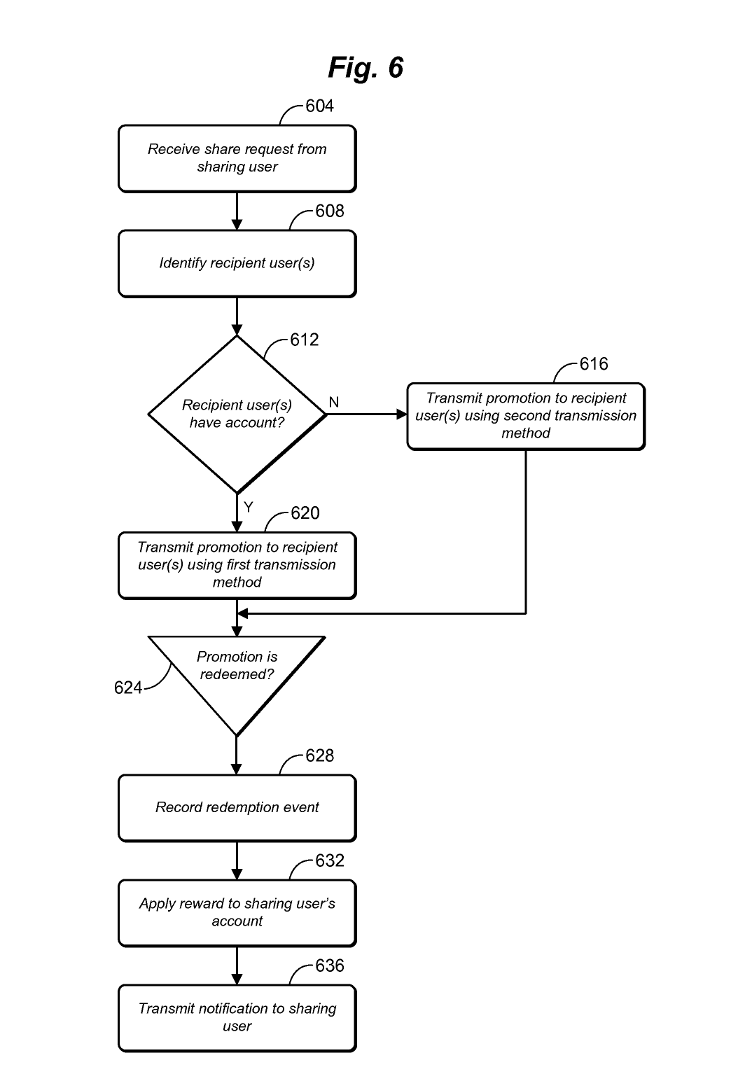

Sharing of promotions will now be described in further detail with reference to FIG. 6. FIG. 6 is a flow diagram illustrating an exemplary process by which promotions may be shared via the analytics system. As will also be described below, the analytics system also rewards users for sharing promotions with others. This is highly advantageous in that users are thus encouraged to further distribute a merchant's promotion. In this manner, the merchant can reach a wider audience.

At a step 604, a share request may be received from a consumer device. Presumably, the user has received a promotion that he or she wishes to share. The user may, for example, engage a “Share” button or the like (such as described with regard to FIGS. 3A-3B) to generate and send the share request to the analytics system.

The share request may include various information. For example, the share request may identify the promotion the user wishes to share, such as by a promotion identifier or the like. The share request may also include information identifying one or more recipient users the sharing user wishes to share the promotion with. It is contemplated that the sharing user may identify recipient users by inputting a user identifier, such as an email address, username, phone number, or other identifier. The sharing user may be prompted to input this information at his or her consumer device.

At a step 608, the analytics system may classify the recipient users. In general, this classification is used to determine a method to transmit a promotion to individual recipient users. For instance, a promotion may be transmitted to recipient users having a user account on the analytics system in a different manner than recipient users without a user account. This is illustrated in a decision step 612 of FIG. 6. In one or more embodiments, the analytics system may compare the user identifiers identifying the recipient users to information in its user account database (or other stored records) to determine if a user has an account. Therefore recipient users having an account may be determined based on various user identifiers.

If it is determined that a recipient user has a user account, then at decision step 612 the promotion may be transmitted in a different way than if the recipient user does not have a user account. As can be seen from FIG. 6 for example, recipient users having user accounts are sent promotions via a first transmission method at a step 620, while recipient users that do not have user accounts are sent promotions via a second transmission method.

In one or more embodiments, users with user accounts will have consumer devices specially configured to interact with the analytics system. For example, their consumer devices may execute machine readable code that is specially configured to communicate with the analytics system. In a smart phone embodiment for example, the consumer device may execute a particular mobile application to communicate with the analytics system. Therefore, recipient users with user accounts may be sent promotions via these applications/consumer devices at step 620. In one or more embodiments, these recipient users may also or alternatively be sent a “push” notification intended for the particular mobile application.

Users without user accounts may not have such specially configured consumer devices, and thus may be sent promotions by other methods. For example, promotions may be sent to such users via “standard” transmission methods. To illustrate, at step 616 a promotion may be sent via email, SMS, instant messaging, push notification, or the like to recipient users that do not have a user account.

It is noted that recipient users need not be classified in some embodiments. For example, the analytics system may share promotions with recipient users based on how they are identified by the sharing user. For instance, recipient users identified by a username may be sent promotions via a specialized mobile application (configured to communicate with the analytics system), while recipient users identified by a phone number or email may be sent promotions by SMS or email, respectively. In other embodiments, promotions may be shared in the same manner regardless of whether a recipient user has a user account or not. For example, the analytics system may only share promotions via a particular method, such as email, SMS, or instant messaging. It is contemplated that promotions may be shared directly between users as well. For example, a sharing user's consumer device may transmit a promotion directly to other users.

Once received by a recipient user, the shared promotion may be viewed and/or redeemed. It is contemplated that the promotion may be further shared as well in some embodiments. At a step 624, if a recipient user redeems the promotion he or she has received from a sharing users, this redemption may be recorded at step 628. For instance, the activity monitor of the analytics system may record such redemption to provide analytics for the same to the merchant that created the promotion.

As described above, the sharing user may be rewarded if a promotion he or she shares is redeemed. This may occur at a step 632, after a recipient user redeems the promotion. Promotion redemption may occur in various ways, such as described above. It is noted that the promotion may include an identifier or flag that indicates it has been shared and/or an identifier of the user that shared the promotion. These identifiers may be included in the promotion itself or may be stored associated with the promotion by the analytics system. In this manner, the sharing user can be identified and subsequently rewarded for the recipient user's redemption.

At step 632, the reward may be applied to the sharing user's account. Rewards may constitute various items. For example, in some embodiments, the user may be rewarded with points, credits or the like that may be redeemed for other items. In other embodiments, the user may be rewarded with currency, prizes, or other items of value.

It is contemplated that a merchant may define the reward that a sharing user receives, and the analytics system may associate this definition with one or more of the merchant's promotions as desired by the merchant. The merchant may be permitted to define rewards in various ways. For example, the merchant may indicate a percentage of the amount spent, a fixed reward for every redemption, or the like as the sharing user's reward. It is noted that the merchant may utilize a merchant device to create the reward definitions.

The rewards may be related to the merchant providing the promotion that was shared and then redeemed. For example, the reward to the sharing user may be for discounted or free goods or services at the merchant that issued the promotion. In one embodiment for example, a sharing user that causes a merchant defined number of recipient users to redeem the promotion receives free or discounted goods or services. Alternatively, the rewards may be various items, currency, credits, points or the like that are not tied to the merchant. In such embodiments, the sharing user may be provided with a wider range of rewards.

The reward may be applied to a sharing user by storing a record of the reward in the sharing user's user account. For instance, a count or sum of the sharing user's points, credits, or currency may be stored in the sharing user's account. It is contemplated that users of the analytics system may view their rewards and/or redeem them via their consumer devices.

At an optional step 636, it is contemplated that the sharing user may be notified of his or her reward. This may occur in various ways. For instance, in one or more embodiments, the user may be sent a notification or alert via his or her consumer device. This provides the user up to date information on the redemption of the promotion(s) he or she has shared.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An analytics system for distributing merchant promotions comprising:
one or more servers configured to:
transmit a promotion to a first consumer device;
transmit the promotion to one or more second consumer devices upon receiving a sharing request from the first consumer device; and
receive interaction data from the one or more second consumer devices, the interaction data identifying a user account associated with the first consumer device; and
one or more storage devices configured to store the interaction data, and record a reward in the user account identified by the interaction data upon receipt of the interaction data.

2. The analytics system of claim 1, wherein the reward is an item of value selected from the group consisting of credits, points, currency, and prizes.

3. The analytics system of claim 1, wherein the one or more storage devices are further configured to store one or more reward definitions, wherein the reward recorded in the user account is defined by the one or more reward definitions.

4. The analytics system of claim 1, wherein the interaction data includes an identifier indicating that the promotion has been redeemed with the one or more second consumer devices.

5. The analytics system of claim 1, wherein the one or more servers are configured to transmit the promotion to the first consumer device with a first transmission method, and to the one or more second consumer devices with a second transmission method, the first transmission method being distinct from the second transmission method.

6. The analytics system of claim 3, wherein the second transmission method is selected from the group consisting of SMS, email, push notification, and instant messaging.

7. The analytics system of claim 1, wherein the one or more servers are further configured to receive one or more user identifiers identifying one or more user accounts associated with the one or more second consumer devices.

8. The analytics system of claim 1, wherein the one or more servers are further configured to generate a report combining interaction data from a plurality of users.

9. An analytics system for distributing merchant promotions comprising:
a promotion distribution system configured to transmit one or more promotions to one or more first consumer devices; and
an activity monitor configured to:
receive interaction data identifying a redemption of the one or more promotions using one or more second consumer devices, the interaction data identifying one or more user accounts associated with the one or more first consumer devices; and
apply a reward to the one or more user accounts by storing an indicator identifying the reward, the indicator may be stored on one or more storage devices and be associated with the one or more user accounts to associated the reward to the one or more user accounts.

10. The analytics system of claim 9, wherein the promotion distribution system is further configured to transmit the one or more promotions to the one or more second consumer devices upon receipt of a share request from the one or more first consumer devices.

11. The analytics system of claim 10, wherein the share request identifies one or more user accounts associated with the one or more second consumer devices.

12. The analytics system of claim 10, wherein the share request identifies one or more user identifiers selected from the group consisting of phone numbers and email addresses.

13. The analytics system of claim 10 further comprising a storage device having machine readable code stored thereon, the machine readable code configured to generate the share request when executed by the one or more first consumer devices.

14. The analytics system of claim 9, wherein the promotion distribution system is configured to transmit the one or more promotions to the one or more first consumer devices by a first transmission method, and to transmit the one or more promotions to the one or more second consumer devices by a second transmission method, the first transmission method being distinct from the second transmission method.

15. The analytics system of claim 9, wherein the reward is an item of value selected from the group consisting of credits, points, currency, and prizes.

16. A method for distributing promotions with an analytics system comprising:
receiving a promotion from a merchant via a merchant device;
receiving a reward definition for the promotion from the merchant;
transmitting the promotion to one or more first consumer devices via a communication device;
receiving interaction data indicating a redemption of the promotion from one or more second consumer devices;
determining a reward based on the reward definition after receiving the interaction data;
associating the reward with one or more user accounts associated with the one or more first consumer devices.

17. The method of claim 16 further comprising transmitting the promotion from the one or more first consumer devices to the one or more second consumer devices.

18. The method of claim 16 further comprising:
receiving a share request from the one or more first consumer devices, the share request identifying at least one of the one or more second consumer devices; and
transmitting the promotion from the analytics system to the at least one of the one or more second consumer devices after the share request is received.

19. The method of claim 16 further comprising transmitting a notification to the one or more first consumer device after the interaction data is received.

20. The method of claim 16 further comprising transmitting information identifying the reward to the one or more first consumer devices upon receipt of a query from the one or more first consumer devices.
